(19) United States
(12) Patent Application Publication
(10) Pub. No.: US 2008/0035133 A1
(43) Pub. Date: Feb. 14, 2008

(54) Single connecting rod engine

(76) Inventors: Irvin V. Patterson, Lee's Summit, MO (US); Stanley L. Patterson, Lee's Summit, MO (US)

Correspondence Address: Mark Manley, University of Central Missouri, Dockery Building Room 102, Warrensburg, MO, 64093, US

(21) Appl. No.: 11/503,590

(22) Filed: Aug. 14, 2006

(51) Int. Cl. F02B 25/00

(52) U.S. Cl. 123/71 R

(57) ABSTRACT

A linear engine including a first and a second cylinder in axial alignment and a a main connecting rod passing through the first and second cylinders.

A first dual sided double acting piston connected to the connecting rod in the first cylinder and a second dual sided double acting piston connected to the connecting rod in the second cylinder subdividing the two cylinders into four combustion chambers.

Lubricant is supplied and returned through the connecting rod to the first and second piston.

### RELATED APPLICATIONS

None

### BACKGROUND OF THE INVENTION

In engine technology there has been an on-going effort to improve the efficiency of engines. There is a need to improve fuel efficiency. At the same time it is desirable to simplify the engine by reducing the number of components, the engine size and by reducing weight. It is particularly desirable to reduce the number and the mass of reciprocating parts within the engine.

U.S. Pat. No. 2,335,252 represents an early attempt to change engine design and to reduce the number of components. Patent '252 shows 4 pistons connected to a crank 34 through a single connecter arm 44. Typical engines would have 4 connector arms, one for each piston. While this was a good idea, the patent shows a massive amount of connecting material; rods 25, braces 29 and 30 and arm 38 and 40. It appears that much of the benefit of reduced connector arms was lost in the mass connecting the 4 pistons. Patent '252 also attempted to take advantage of the idea of linear acting pistons. Linear action can reduce drag caused by uneven forces, sometimes called piston slap, in engines with reciprocating connector arms connected directly to the pistons. But the attempt of '252 is massive as mentioned and would still have some uneven torque applied about the center of mass of the pistons as each individual piston fires.

U.S. Pat. No. 6,854,429 is another attempt to use multiple linear pistons attached through a lesser number of connector arms to reduce engine mass, to reduce mass of moving parts and to reduce uneven torque and piston slap. Patent '429 uses double sided pistons 124 and linear connecting rods 130. The double sided pistons allow for firing at both ends of the cylinder yielding a 4 piston engine in the space of 2 cylinders, reducing reciprocating and stationary weight. The linear engine '429 should also reduce uneven torque such as piston slap. There are still many parts and a substantial size to this engine. Another problem with '429 is that by supplying lubricant through the cylinder wall, it forces the dual sided piston to be long, long enough for the lubricant supply 202 to stay in the open area 124 between the two sets of rings. This means the pistons must be at least the length of the stroke plus two sets of rings. Length of piston increases total engine mass, reciprocating mass and engine size, all negatives.

There is a need for a combustion engine having reduced mass, particularly reduced mass of moving parts. There is also a need for engines having reduced uneven forces induced by the firing of pistons.

### SUMMARY OF THE INVENTION

In one aspect of the invention, a linear engine includes a first and a second cylinder in axial alignment. A main connecting rod passes through each of the cylinders to connect a first dual sided piston to a second dual sided piston.

Each piston divides a cylinder into two combustion chambers; meaning the two cylinders give four combustion chambers. Lubricant under pressure is supplied and returned through said connecting rod to the first and the second piston.

These and other advantages of the present invention will become apparent from the detailed description of the invention.

### BRIEF DESCRIPTION OF THE DRAWINGS

FIG. 1 A shows a simplified block diagram of the engine;

FIG. 1B shows a partial view along line B-B;

FIG. 2 A-D shows a block diagram of the engine stroke sequence;

FIG. 3 A shows details of the engine output connections;

FIG. 3 B shows details of the engine output connections;

FIG. 3C-3F show a block diagram of the crank shaft connection through one revolution of the engine;

FIGS. 4 and 4A show lubrication details;

FIG. 5 shows an alternate embodiment of the engine;

FIG. 5A shows details of the second embodiment;

FIG. 5B shows details of the second embodiment;

FIG. 6 shows details of an alternate embodiment of lubrication detail of the engine;

FIG. 6 A shows details of the lubrication detail of FIG. 6 for the alternate embodiment;

FIG. 7 shows details of a superdischarger for the second embodiment;

FIG. 8 shows details of a third embodiment;

FIG. 9 shows details of the second embodiment;

FIG. 10 shows details of a piston;

FIG. 11 shows a fourth embodiment, a four cycle engine;

FIGS. 12 and 12 A show details of a supercharger piston; and

FIGS. 13 and 13A discloses a fifth embodiment with a simplified housing.

### DETAILED DESCRIPTION OF THE DEVICE

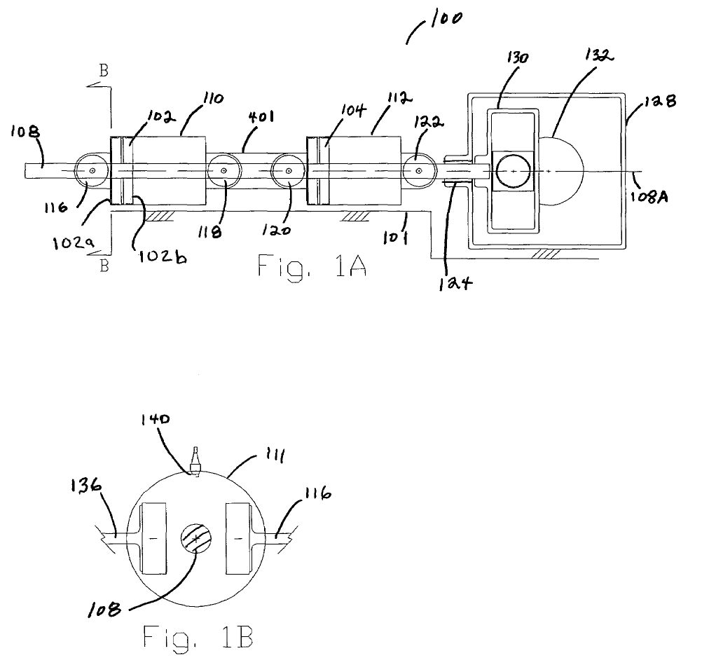

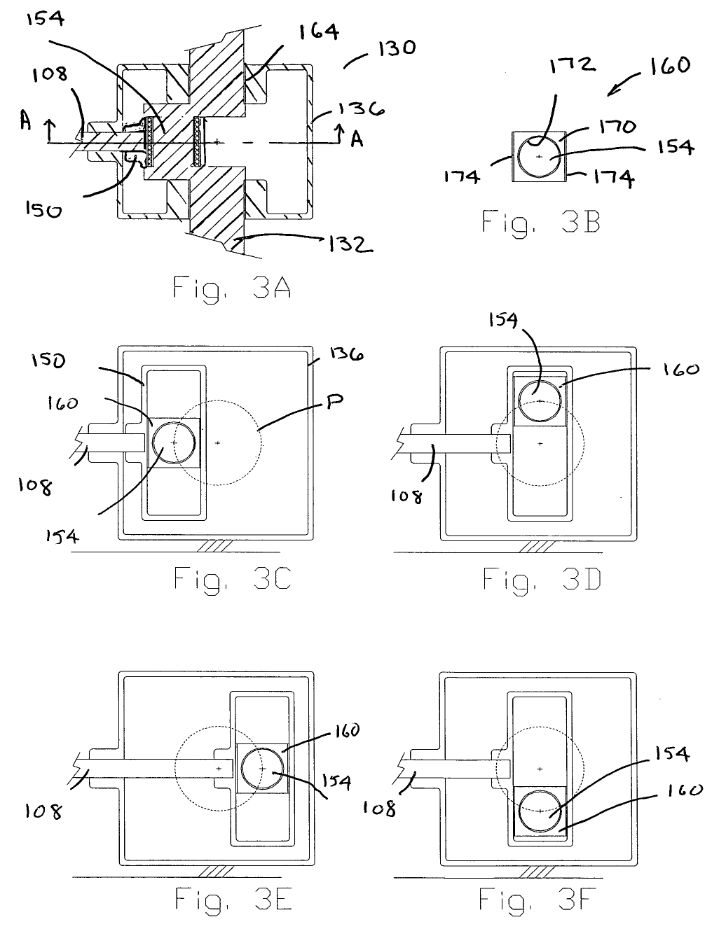

FIG. 1 A shows a simplified cutaway block diagram view of the engine 100. In the engine 100 there is a block 101 and there are two dual sided double acting pistons 102 and 104 affixed to an axially movable main connecting rod 108. Dual sided double acting pistons 102, 104 provide power in two directions and have two opposed combustion faces 102a and 102b. The main connecting rod 108 is linear and passes through two axially aligned cylinders 110 and 112 on a central axis 108 A for the cylinders 110, 112. Each cylinder 110, 112 includes intake valves 116, 118, 120, 122 and there are 4 exhaust valves not shown in this view (see FIG. 1B). The valves 116, 118, 120 and 122 are mounted to move perpendicular to the main rod 108 which reduces the length of the engine and would eliminate the possibility of piston-valve collision. The main rod 108 can ride in linear bearings 124 and has an end connected to a power output 128 through takeoff coupling 130 to a crankshaft 132. Details of the power takeoff coupling 130 are shown in FIG. 3. It can be seen from FIG. 1A that each piston 102, 104 divides its cylinder 110, 112 into two combustion chambers, one on each side of the piston.

FIG. 1B shows the view from cut line B-B. This view shows the end section 111 of a cylinder 110. The end section 111 is typical of each end of each cylinder 110, 112. The end 111 includes intake valve 116 and an exhaust valve 136. The main rod 108 passes through the end 111 and each end can include an ignition devices such as a spark plug 140 or for a diesel (not shown) a glow plug and fuel injector.

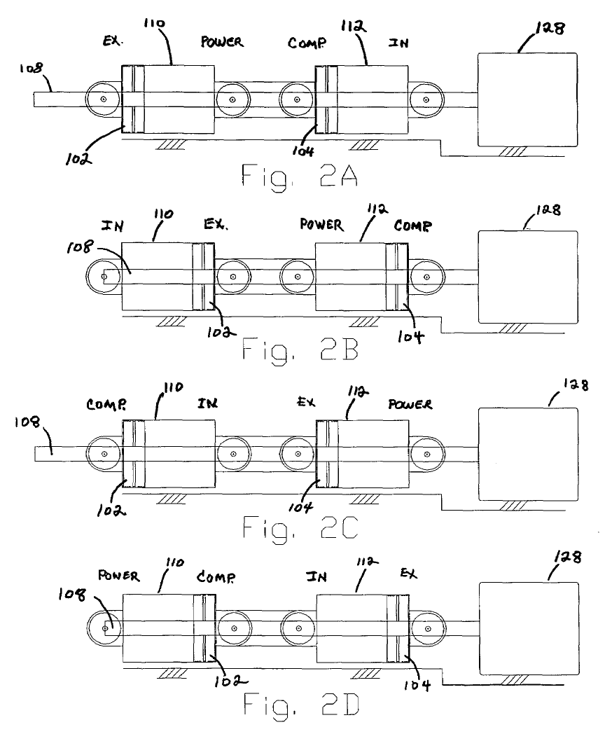

FIGS. 2A through 2D show the sequence of movement through the engine cycle. The engine 100 shown is a 4 cycle engine: Intake (IN), Compression (COMP), Power, and Exhaust (EX). In a normal 4 cycle engine the strokes occur one at a time in sequence for each cylinder. As can be seen in the engine 100 each of the 4 strokes are occurring at any time. Essentially the two cylinders 110 and 112 and pistons 102, 104 function the same as a normal 4 cycle 4 cylinder piston engine.

In FIG. 2A the main connecting rod 108 has just reached the left most position with piston 102 completing the exhaust (EX) stroke on the left side of cylinder 110 and completing the power stroke on the right side of piston 102. In cylinder 112 the piston 104 has just completed the compression (COMP) stroke on the left side and the intake (IN) stroke on the right side. FIG. 2B shows the end of the next stroke, in cylinder 110 the piston 102 has completed the intake (IN) on the left and the exhaust (EX) on the right. Piston 104 has completed the power on the left and the compression (COMP) on the right. In FIG. 2C the piston 102 has just completed the compression (COMP) on the left and the intake (IN) on the right. In FIG. 2C Piston 104 has just completed the exhaust (EX) on the left and the power on the right. In FIG. 2D piston 102 has just completed the power stroke on the left and the compression (COMP) on the right. In FIG. 2D piston 104 has just completed the intake (IN) on the left and the exhaust (EX) on the right. After 2D the next stroke returns the arrangement to the position shown in 2A and the cycle starts over. Though not shown, it will be understood by those skilled in the art that the inlet and exhaust valves can be operated by cam followers acting on a cam shaft or by electronically controlled actuators. It will also be understood that gasoline, diesel or other fuel can be injected as needed.

FIG. 3A shows a cross-sectional view of the crankcase 130 including the crankcase housing 136. The crankcase 130 includes a crankshaft follower carriage 150 and a crankshaft 132. The crankshaft 132 can be fairly conventional with crankshaft throw portions 154. The engine main rod 108 is connected at an end to a carriage 150 that encloses sub-carriage 160 and surrounds the crankshaft throw portion 154. Details of the sub-carriage 160 are shown in FIG. 3B. Main bearings 164 are provided for the crankshaft 132 to ride on either end of the crankcase housing 136.

FIG. 3B shows details of the sub-carriage 160 which includes a housing 170, bearing sleeve 172, connecting the sub-carriage to the crankshaft throw 154 and surface bearings on each end 174 where the housing of the sub-carriage 160 bears against both side of the inside of the carriage 150.

FIGS. 3C-3F are taken at the cross section line A-A in FIG. 3A and show the operation of the crankcase 130 in converting the linear power from the pistons 102, 104 through main rod 108 to rotational power. In the crank case housing 136 the sub-carriage 160 follows the path of the crankshaft throw 154 shown as a dashed line circle P. Starting with 3C it can be seen that as the pistons 102, 104 push the main rod 108 to the right the sub-carriage 160 is driven up and to the right, following the crankshaft throw 154, as shown in FIG. 3D. The sub-carriage 160 and main rod 108 push the carriage 150 to the right while the sub-carriage 160 moves upward within the carriage 150 relative to the carriage 150. From the position in FIG. 3D the crankshaft throw 154 and sub-carriage 160 move down and to the right to the position shown in 3E. At 3E the main rod 108 is fully to the right. The crankshaft throw 154 and sub-carriage 160 then move down and to the left to the position shown in FIG. 3F and finally return to the position shown in 3C. The cycle from FIGS. 3C through 3D to 3E to 3F and back to 3C occurs in the same time as the cycle from FIGS. 2A to 2B to 2C. That is to say there are 2 power stokes (one per piston 102, 104) for each revolution of the crankshaft 132.

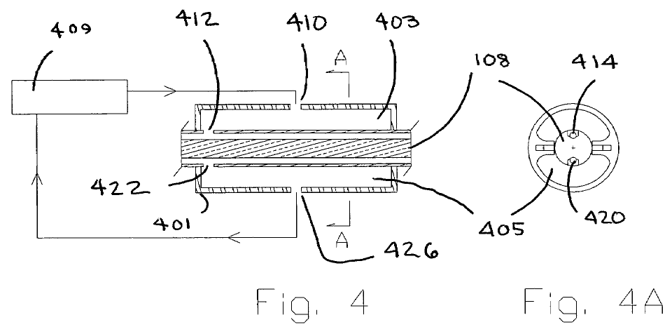

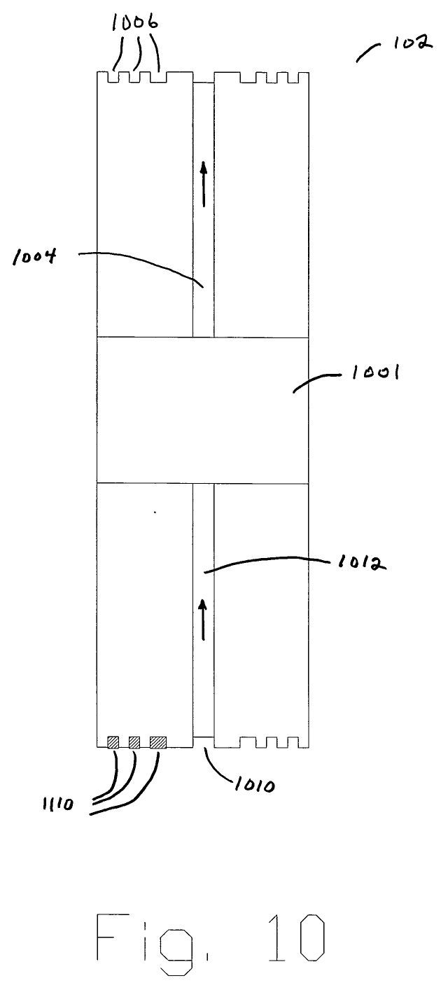

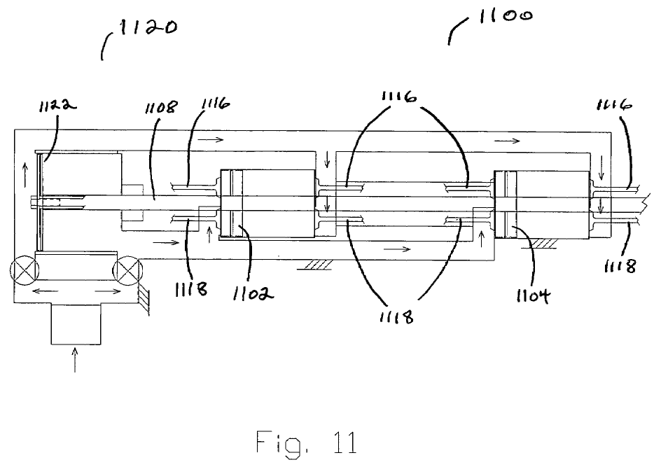

FIG. 4 shows a cross sectional view of details of the engine block 101 including a portion 410 guiding lubricant to the main rod 108. FIG. 4 shows how lubricant travels into and through the main rod 108 to get to and return from the piston rings (See FIG. 10). FIG. 4 A shows a cross section through A-A in FIG. 4. The lubrication portion 401 of the engine block 101 is shown between the cylinders 110 and 112 in FIG. 1. The main rod 108 passes through the upper cavity 403 and lower cavity 405 contained within portion 401. Lubricant, supplied by a source such as an lubricant pump 409, under pressure is supplied through port 410 into upper cavity 403, the lubricant then travels into the main rod 108 through port 412 and through tube 414 to both pistons 102, 104. The lubricant then circulates to the ring grooves of the pistons and back (See FIG. 10 for details of piston lubrication). Return lubricant travels back through tube 420 through port 422 into lower cavity 405 and exits port 426 to return to supply lubricant for lubricant pump 409. Seals 430 separate upper cavity 403 from lower cavity 405 along the portion of the length of main rod 108 within the lubrication portion 401.

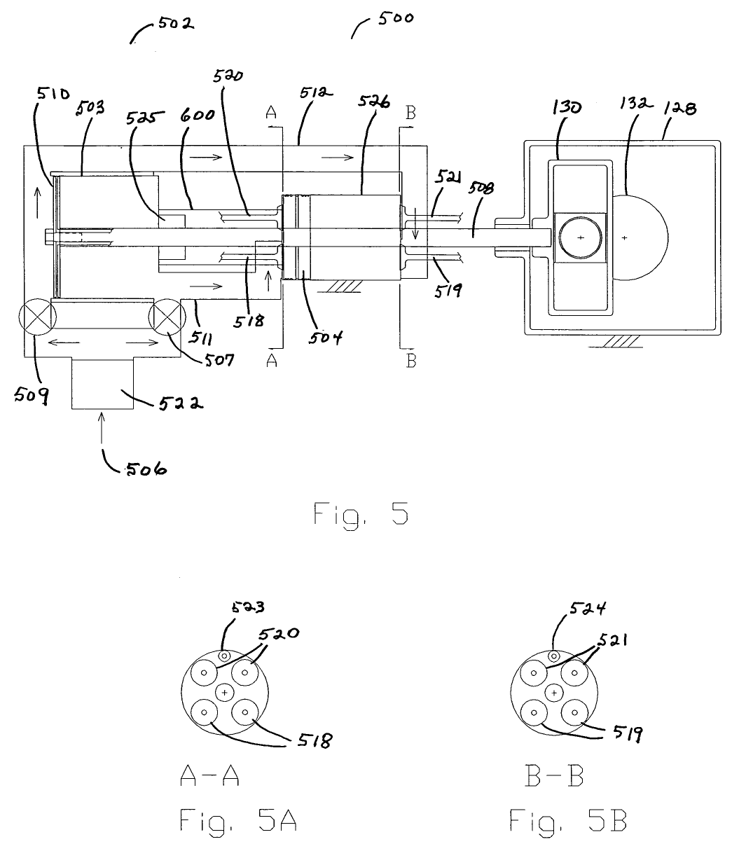

FIG. 5 shows an alternate embodiment of the invention, an engine 500 in this case a two cycle engine with super charger 502 having supercharger cylinder 503. FIG. 5 shows the main connecting rod 508 in its left most position. Engine 500 has a power stroke for each direction of movement of the main connecting rod 508. Intake valves 518, 519 and exhaust valves 520, 521 are mounted parallel to the main connecting rod 508. Inlet airflow in FIG. 5 is shown with arrows. Air flows into air inlet 506 through filter 522 and through valve 507 or 509 that opens and closes as super charger piston 510 moves. 525 is a linear bearing that carries the main connecting rod 508.

As shown in FIG. 5, the compression stroke for the left side of piston 504 has just been completed. On the right side of piston 504 the intake from manifold 512 has just been completed. All intake valves 518 and 519 are now closed. All exhaust valves 520 and 521 are also closed. Supercharger valve 509 is open to allow air piston 510 to draw fresh air into the left side of the air piston 510. Valve 507 is closed at the right time, as programmed, to allow air previously drawn into the right side of piston 510 to be forced into the intake valves 518 to the left of piston 504 as they open. The timing of closure of electronic valve 507 can control the amount of air introduced into the cylinder 526 through intake valves 518. Valves 507 and 509 control the amount of air introduced allowing excess air to escape to the other side of air piston 510.

As injectors 523 inject fuel in the left side of piston 504, ignition occurs due to the hot compressed air and the power stroke begins and the pistons 504 and 510 move to the right in FIG. 5. After piston 504 has extracted most of the available power near the right most end of cylinder 526, the exhaust valves 520 on the left end of cylinder 526 are opened allowing the exhaust gases to escape. Next, the intake valves 518 on the left end are opened so the compressed air in intake manifold 511 can help scavenge the exhaust. Next, the exhaust valves 520 are closed and fresh air is pushed into the cylinder 526 from intake manifold 511 and then intake valves 518 are also closed. With the piston 504 now fully to the right end of cylinder 526, the compression stroke has just been completed on the right side of piston 504 and the new power stroke begins on the right side of piston 504. On the left side of piston 504, the intake of air from intake manifold 511 has just been completed. Supercharger valve 507 is open to allow air piston 510 to draw fresh air into cylinder 503 to the right side of piston 510. Valve 509 is closed at the appropriate time, under program control, to achieve the desired boost for intake manifold 512.

As injector 524 injects fuel in the cylinder 526 to the right of piston 504, ignition occurs due to the hot compressed air and the power stroke begins. After piston 504 has extracted most of the available power near the left-most position, the exhaust valves 521 on the right end of cylinder 526 are opened allowing exhaust gases to escape. Next the intake valves 519 are opened so the compressed air in the intake manifold 512 can help scavenge the exhaust. Next the exhaust valves 521 are closed and fresh air is pushed into cylinder 526 from the intake manifold 512 and then intake valves 519 are closed. This completes a full cycle of the engine 500 returning the pistons 510 and 504 to the position shown in FIG. 5.

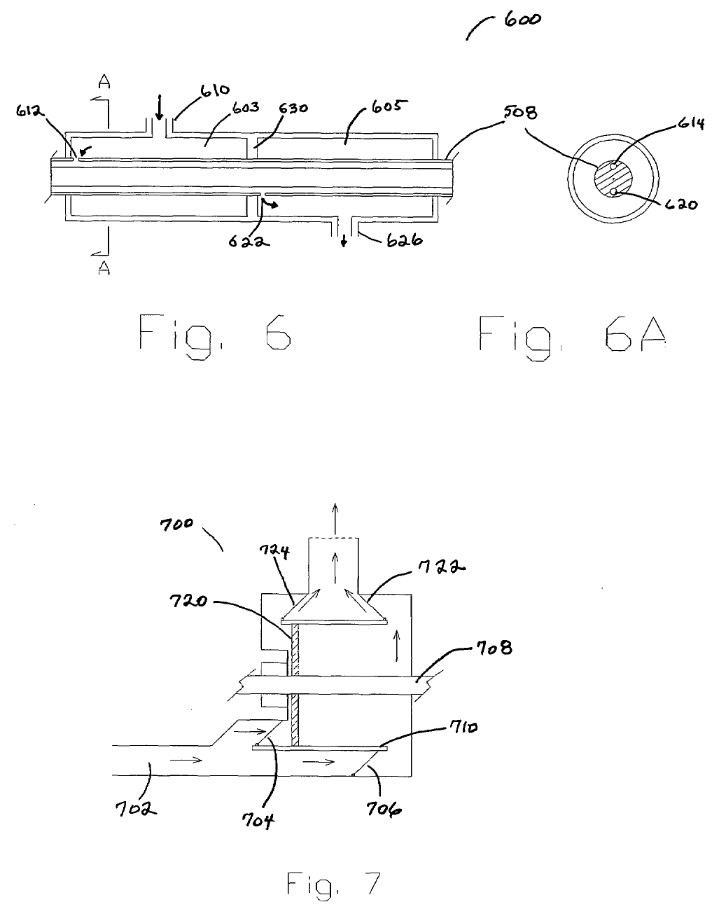

It will be understood that the intake valves 518 and 519 and exhaust valves 520, 521 as well as supercharger valves 507,509 in the second embodiment can be driven by cam followers or by electronic means including computer control. Lubricant is provided to the pistons 504 and 510 through the main connecting rod 508 through lubrication supply 600 detailed in FIG. 6.

FIG. 6 shows a cross sectional view of details of the engine lubrication system 600 of the second embodiment engine 500. FIG. 6 shows how lubricant travels into and through the main rod 508 to get to and return from the piston rings (see FIG. 10). FIG. 6 A shows a cross section through A-A in FIG. 6. The lubrication system 600 is shown at the left end of cylinder 526 in FIG. 5 and details are shown in FIG. 6. The main rod 508 passes through the left cavity 603 and right cavity 605 contained within the lubrication system 600. Lubricant under pressure is supplied through port 610 into left cavity 603, the lubricant then travels through the main rod 508 through port 612 and through tube 614 to both piston 504 and to air piston 510. The lubricant then circulates to the ring grooves of the pistons 504, 510 and back (See FIG. 10 for details of the piston lubrication). Return lubricant travels back through tube 620, through port 622 into right cavity 605 and exits port 626 to return to supply lubricant. Seal wall 630 separates left cavity 603 from right cavity 605 along the portion of the length of main shaft 508 within lubrication system 600.

FIG. 7 shows details of a super discharger 700 that can be used in a third embodiment of the invention. Arrows in FIG. 7 indicate the direction of airflow. The super discharger 700 is powered by an extension of the main connecting rod 708. Exhaust from the engine 701 is supplied through and exhaust manifold 702. Low mass one way valve 704, 706 allow exhaust to enter the main super discharger cylinder 710. Exhaust tends to be drawn into the cylinder 710 by movement of the piston 720 which moves with main rod 708. As the piston 720 moves to the right in FIG. 7 it draws exhaust through one way valve 704 and forces exhaust to the right of piston 720 out through one way valve 722. When piston 720 moves to the left in FIG. 7 it draws exhaust through valve 706 and forces exhaust out through valve 724. The super discharger 700 allows exhaust to be removed faster than would be possible without the super discharger 700.

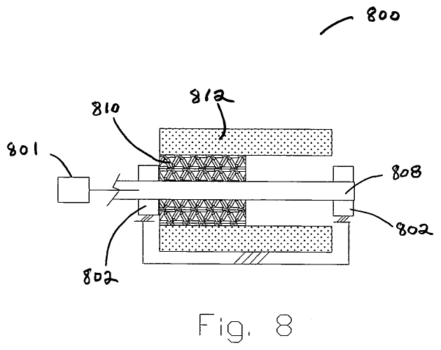

FIG. 8 shows an alternate way of taking energy from an engine using this invention. Power extraction device 800 uses electric windings 812 and a linear reciprocating armature 810 to convert power from the engine 801 to electrical power. The main connecting rod 808 rides in linear bearings 802. It will be understood by those skilled in the art that other electrical, mechanical or fluid means of taking power from the engine could be used.

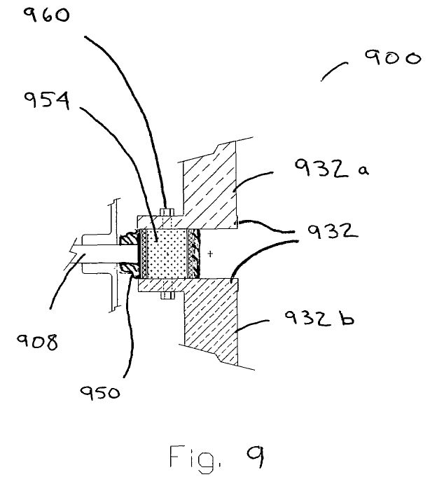

FIG. 9 is a cross-sectional view showing details of yet another alternate embodiment 900. The embodiment 900 uses a multi-piece crankshaft 932 connected to the main rod 908 which passes through the linear pistons as shown for other embodiments. The multi-piece crankshaft 932 makes assembly of the crankshaft to the carriage 950 easier. The crankshaft throw 954 is attached to two sections 932a and 932b of the crankshaft 932 using bolt 960.

FIG. 10 shows a cross-sectional view taken through a cylindrical piston 102 of the engine 100. The piston 102 includes a central opening 1001 sized for the main rod 108. Central lubricant passage 1004 receives lubricant from the main connecting rod 108, as explained in FIG. 4, and the lubricant travels radially outwardly to the piston ring grooves 1006. It will be understood that the rings 1110, shown in section are conventional piston rings that encircle the piston 102 and fit down in the grooves 1006. Lubricant travels circumferentially around the rings 1110 and central lubricant groove 1010 and returns via central return passage 1012 back to the main connecting rod 108 for recirculation. Though piston 102 is shown other pistons 104, 504, 1102 and 1104 would be similar in construction.

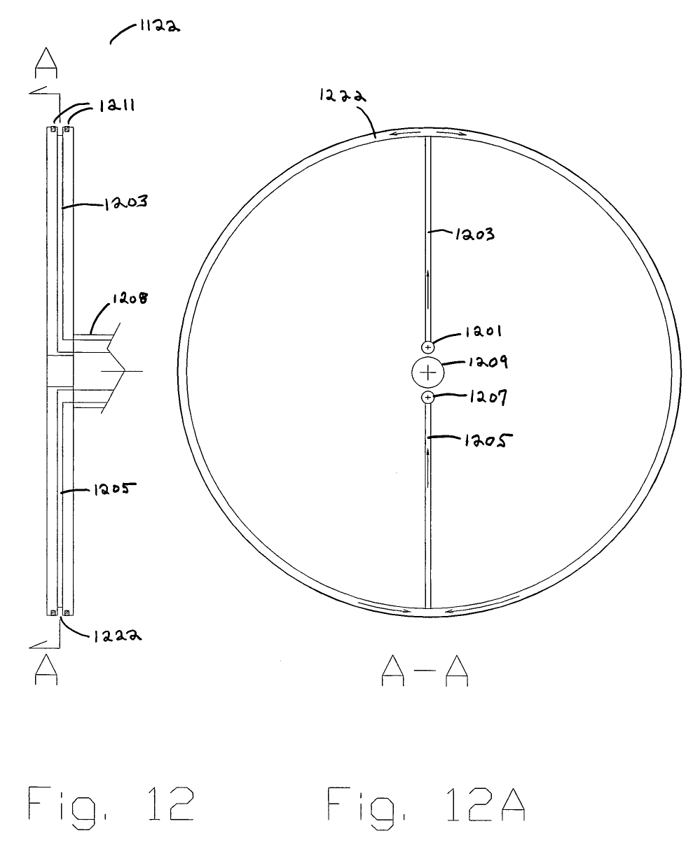

FIG. 11 shows an alternate embodiment 4 cycle engine 1100 with the intake valves 1116 and exhaust valves 1118 oriented parallel to the main connecting rod 1108 running through pistons 1102 and 1104. The engine 1100 includes a piston 1122 operated supercharger 1120 similar to the supercharger of the embodiment shown in FIG. 5.

FIGS. 12 and 12 A show details of the supercharger piston 1122 and how lubricant flows to and from the main connecting rod 1108. Supply lubricant from the rod 1108 flows through port 1201 and out through duct 1203. The supercharger piston 1122 is mounted to connecting rod 1108 by a bolt through opening 1209. Lubricant returns through duct 1205 to port 1207 where it transfers back to the connecting rod 1108 and returns to supply. FIG. 12 shows a sectional side view of piston 1122 with rings 1211 which are on either side of ducts 1203 and 1205 such that lubricant can travel from duct 1203 through the circumferential groove 1220 between the rings 1211 and to duct 1205. Arrows in FIG. 12A show direction of flow.

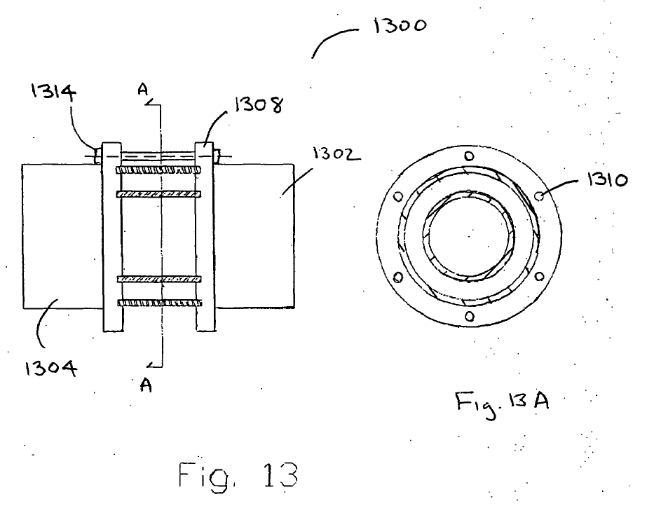

FIGS. 13 and 13 A show an alternate embodiment of the engine 1300, where the engine 1300 is formed by a bolt together housing 1302. Two identical outer housings 1304 include flanges 1308 having a plurality of bolt holes 1310. Two housings 1304 are bolted together using bolts 1314 passing through each bolt hole 1310 in the flanges 1308. The two housings sandwich two cylindrical housings 1320 and 1322. The inner wall of the inner cylindrical housing 1320 forms the piston cylinder 1324. The outer cylindrical housing 1322 forms a cooling jacket in the space 1330 between the inner and outer cylindrical housings 1320 and 1322. It will be understood by those skilled in the art that the engine shown in FIG. 1 or 5 could be placed inside this housing 1304.

Though only a single set of axially aligned cylinders 110, 112 are shown it will be understood by those in the art that a number of sets of cylinders could be provides supplying power to a single output device such as a crankshaft. It will also be understood that the main connecting rod can be composed of one or more axially aligned sections connected together to form a single connecting rod.

While the invention has been described in reference to preferred embodiments, it is not necessarily limited to the particulars set forth. On the contrary, it is intended to cover such alternatives, modifications and equivalents as set forth in the spirit and scope of the invention as defined by the appended claims.

1. A linear engine including;
a first and a second cylinder in axial alignment;
a main connecting rod passing through said first and second cylinders;
a first dual sided piston connected to said connecting rod in said first cylinder and a second dual sided piston connected to said connecting rod in said second cylinder;
lubricant supplied through said connecting rod to said first and said second piston.

2. The linear engine of claim 1 wherein an end of said main connecting rod is connected to a crankshaft.

3. The linear engine of claim 1 wherein said first and second dual sided pistons divide said first and second cylinders each into two combustion chambers wherein each said combustion chamber includes a spark plug, an inlet valve and an exhaust valve and wherein said engine is a four cycle engine.

4. The linear engine of claim 3 including a supercharger, said supercharger including a supercharger piston attached to said connecting rod and coaxial with said connecting rod, said supercharger supplying air to said combustion chambers.

5. The linear engine of claim 1 wherein said lubricant travels from a source of lubricant through said connecting rod to said first piston and travels radially outwardly through said piston to piston rings and then returns through said connecting rod to said source of lubricant.

6. The linear engine of claim 2 wherein said connecting rod is connected to said crankshaft by a carriage connected to a throw of said crankshaft.

7. The linear engine of claim 1 wherein an end of the main connecting rod is connected to an armature that drives a linear electric generator and said linear engine is a four cycle engine.

8. A linear engine including;
a first and a second cylinder in axial alignment;
a main connecting rod passing through said first and second cylinders, wherein said connecting rod is on a central axis for the first and second cylinders;
a first dual sided double acting piston connected to said connecting rod in said first cylinder and a second dual sided double acting piston connected to said connecting rod in said second cylinder;
wherein each said first and second pistons divide each of said first and second cylinders into two combustion chambers;
lubricant under pressure supplied and returned through said connecting rod to said first and said second piston.

9. The linear engine of claim 8 wherein an end of said main connecting rod is connected to a crankshaft.

10. The linear engine of claim 9 wherein each said combustion chamber includes a spark plug, an inlet valve and an exhaust valve and wherein said engine is a four cycle engine.

11. The linear engine of claim 10 wherein said lubricant travels from a source of lubricant through said connecting rod to said first and second pistons and travels radially outwardly through said pistons to piston rings and then returns through said connecting rod to said source of lubricant.

12. The linear engine of claim 11 wherein said connecting rod is connected to said crankshaft by a carriage connected to a throw of said crankshaft, said carriage includes a sub-carriage that rotationally mounted to said throw and said sub-carriage moves within said carriage such that said connecting rod is fixed to said carriage.

13. A linear engine including;
a main connecting rod passing through at least a first and second cylinder;
a first dual sided double acting piston connected to said connecting rod in said first cylinder and a second dual sided double acting piston connected to said connecting rod in said second cylinder;
wherein each said first and second pistons divide said first and second cylinders into two combustion chambers;
lubricant under pressure for said pistons supplied and returned through said connecting rod.

14. The linear engine of claim 13 wherein said lubricant is supplied to said first and said second dual sided double acting pistons.

15. The linear engine of claim 14 wherein said first and second dual sided double acting pistons divide said first and second cylinders each into two combustion chambers and wherein each said combustion chamber includes an ignition device, a source of fuel an air inlet valve and an exhaust valve.

16. The linear engine of claim 15 wherein said lubricant travels from a source of lubricant through said connecting rod to said first piston and travels outwardly through said piston to piston rings and then returns through said connecting rod to said source of lubricant.

17. A linear engine including;
a linear connecting rod passing through a first cylinder and a second cylinder coaxial to the first cylinder;
a first dual sided double acting piston in said first cylinder said first dual sided piston affixed to said linear connecting rod;
a second piston in said second cylinder said second piston affixed to said linear connecting rod;
wherein said first dual sided double acting piston divides a first cylinder into two combustion chambers and wherein said second piston pumps intake air to said first cylinder from a second cylinder.

18. The linear engine of claim 17 wherein lubricant is supplied and returned through said linear connecting rod to said first and said second piston.

19. The linear engine of claim 17 wherein the second piston is a dual sided piston acting to pump air to the first cylinder at each stroke of the linear connecting rod.

20. The linear engine of claim 18 wherein each said combustion chamber includes a spark plug, an inlet valve and an exhaust valve and wherein said engine is a two cycle engine.
